(19) United States
(12) Patent Application Publication
(10) Pub. No.: US 2011/0305433 A1
(43) Pub. Date: Dec. 15, 2011

(54) Systems and Methods for Automatically Selecting Video Templates and Audio Files and Automatically Generating Customized Videos

(76) Inventor: Jeffrey David Singer, Westfield, NJ (US)

(21) Appl. No.: 12/791,953

(22) Filed: Jun. 2, 2010

(51) Int. Cl. G11B 27/02; H04N 9/80; G11B 27/00; H04N 5/93

(52) U.S. Cl. 386/248; 386/E05.034; 386/290; 386/240

(57) ABSTRACT

Systems and methods for automatically selecting video templates and audio files based upon the analysis of static or dynamic data stored in a database using predetermined criteria and automatically generating customized videos via integration of data from one or more databases. A specific video template is assigned to each current topic. Each variable required to customize the video template is associated with customizable data such as text, image, audio, and video data. The customizable data is presented to the viewer while the video template is played, thereby presenting a customized video to the viewer. The video templates may be theme and/or story based. Each video template may be identified by a multi-digit Video ID. One or more digits of the Video ID may be used to select one or more customizable data for presentation during playing of the video template in accordance with the variables contained in the video template.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

Embodiments of the present invention generally relate to systems and methods for automatically selecting video templates and audio files and automatically generating customized videos. More specifically, the present invention relates to systems and methods for automatically selecting video templates and audio files based upon the analysis of static or dynamic data stored in a database using predetermined criteria and automatically generating customized videos via integration of data from one or more databases.

Today, video content is widely available for download by a large audience of viewers via communication mediums such as satellite, cable, the Internet, and cellular networks. In some instances, the video content is wholly original content (i.e., video content that does not incorporate previously created media content). The creation of original video content requires an extensive production process including a variety of actions such as scripting the dialogue and actions, shooting and directing the video footage, editing the video footage, editing the audio content, designing the graphical elements, and the like.

In other instances, the video content is generated in whole or in part by compiling previously existing media content. This process is similar to that used to create wholly original content with the exception of shooting the video footage. That is, the video producer must edit and integrate all of the media elements in a manner that creates a finished video product. Media elements can include images, text, audio, animation and video clips. The producer must arrange the elements in order to create the story or theme of the video and then add effects such as transitions, narration, background, and audio and visual elements (e.g., pictures, graphics, etc). In addition, the audio and visual elements of the video must be synchronized, which includes removal of unwanted portions of the video.

Media providers and aggregators often store large amounts of media content such as video footage, audio, images, animation, and text. Such media content is typically stored in a database, content repository, data management systems, or the like. The content may be viewed by consumers through many different mediums including television, personal computer, cellular devices, etc. and may be delivered to the viewer via the World Wide Web, cable or digital television connections, wireless data transmission, and the like.

A common example of a content repository is a database on a Web server. A user navigates to a Web page via its World Wide Web address in a Web browsing application and then views and interacts with the page. However, the content viewed by the user is a Hypertext Markup Language (“HTML”) file comprised of many media elements stored on the Web server and is generated automatically in response to the request by the browsing application to retrieve and display the Web page. The database from which the HTML file is created can include text, audio, animation, images and video. The system by which the files are retrieved and displayed is typically an automated system in which a template for structure of the Web page is used and various media elements that are required to create a completed HTML file are incorporated. That is, the required media elements are automatically incorporated into the HTML template based on predetermined criteria. Additionally, the data in the repository can be dynamically updated in order to display current and relevant information to the user in the HTML file. In this manner, the storage, retrieval, and display of dynamic Web pages, media content and HTML files can be an automated process after the initial setup of the database, server and HTML template is complete.

### BRIEF SUMMARY OF THE INVENTION

Briefly stated, a method for automatically creating a customized video is provided. This method includes the following steps: creating a plurality of video templates; associating each of a plurality of available topics with one of the plurality of video templates, the associating performed based upon analysis of at least one of the group consisting of static data related to the plurality of available topics, dynamic data related to the plurality of available topics, and combinations thereof; receiving a current topic from a viewer; identifying a first one of the video templates associated with the current topic; associating customizable data with each of a plurality of variables required to customize the first one of the video templates; and presenting the customizable data associated with each one of the plurality of variables in conjunction with playing of the first one of the video templates to provide a viewer with the customized video.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIGS. 1A through 1B depict a flowchart of the steps of a process for automatically generating and playing a customized video based upon the video template associated with the Video ID selected in the process of FIG. 2 in accordance with one embodiment of the present invention;

FIG. 2 depicts a flowchart of the steps of a process for automatically assigning a video template and/or one or more audio files to a topic ID value by analyzing static and dynamic data in accordance with one embodiment of the present invention;

FIG. 3 depicts a schematic view of an exemplary network environment within which various embodiments of the present invention may be implemented; and

FIG. 4 is a block diagram of an exemplary computing environment within which various embodiments of the present invention may be implemented.

### DETAILED DESCRIPTION OF THE INVENTION

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a step” includes a plurality of steps. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

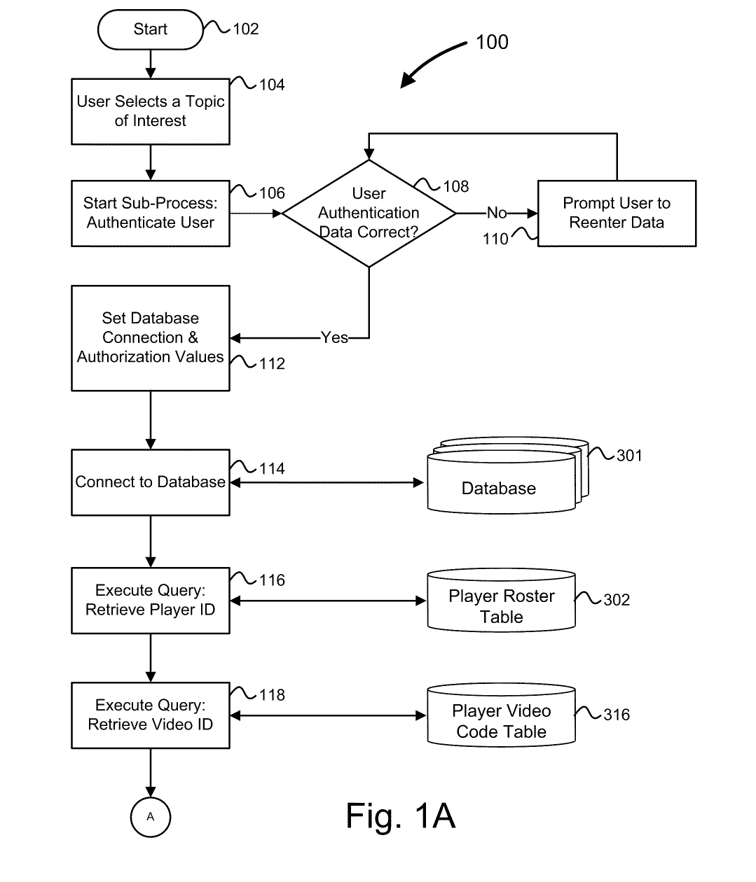

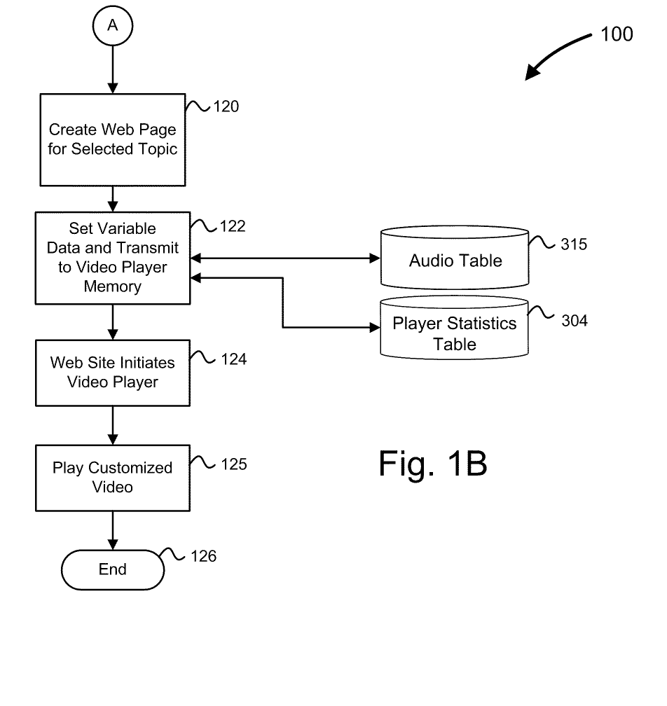

Referring first to FIGS. 1A and 1B, depicted is a method for automatically generating and playing a customized video based upon selection of a video template and/or one or more audio files in accordance with one embodiment of the present invention, wherein the selection of a video template and/or one or more audio files is based upon an analysis of static and dynamic data. That is, a video with customized audio, image, text, and/or video content is automatically generated by an automated process or at the user's request. In the embodiment of the present invention depicted in FIGS. 1A through 4, the video template is a video that includes placeholders into which text, image, audio, and/or video is inserted during playing of the video such that the video of the video template and the inserted text, image, audio, and or video are presented to the user as one seamless customized video. However, alternate forms of video templates may be substituted without departing from the scope of the present invention. The customized video is created by incorporating specific information and/or data along with one or more generic or specific audio files about a topic into a predetermined generic video template. In some embodiments of the present invention, the generic video template includes a theme or story related to the topic of interest.

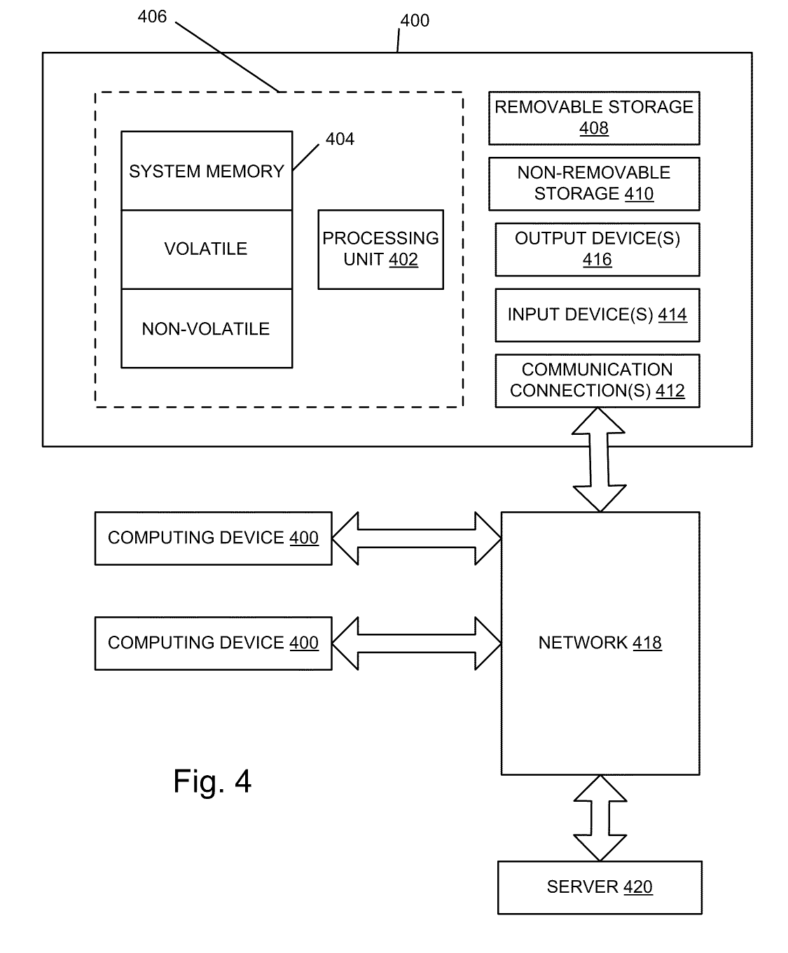

Prior to discussing the methods of the present invention, reference is made to FIG. 4 in which an exemplary system for implementing embodiments of the present invention is depicted. This exemplary system includes, inter alia, a computing device, such as computing device 400. In its most basic configuration, computing device 400 typically includes at least one processing unit 402 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 4 by dashed line 406. Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes or is provided with a variety of computer-readable media. Computer-readable media can be any available media that can be accessed by computing device 400 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 404, removable storage 408, and non-removable storage 410 are all examples of computer storage media. Computer storage media includes, but is not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 400. Any such computer storage media may be part of computing device 400.

Computing device 400 may also contain communications connection(s) 412 that allow the device to communicate with other devices. Each such communications connection 412 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (“RF”), infrared and other wireless media. The term computer-readable media as used herein includes both storage media and communication media.

Computing device 400 may also have input device(s) 414 such as keyboard, mouse, pen, voice input device, touch input device, etc. Output device(s) 416 such as a display, speakers, printer, etc. may also be included. All these devices are generally known to the relevant public and therefore need not be discussed in any detail herein except as provided.

Notably, computing device 400 may be one of a plurality of computing devices 400 inter-connected by a network 418. As may be appreciated, the network 418 may be any appropriate network, each computing device 400 may be connected thereto by way of a connection 412 in any appropriate manner, and each computing device 400 may communicate with one or more of the other computing devices 400 in the network 418 in any appropriate manner. For example, the network 418 may be a wired or wireless network within an organization or home or the like, and may include a direct or indirect coupling to an external network such as the Internet or the like. Likewise, the network 418 may be such an external network. Computing device 400 may connect to a server 420 on the Internet via such an external network.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application-program interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a network 418 or a distributed computing environment. Still further, aspects of the presently disclosed subject matter may be implemented in or across a plurality of processing chips or devices, and storage may similarly be effected across a plurality of devices in a network 418. Such devices might include personal computers, network servers, and handheld devices, for example.

Referring now to FIG. 1, process 100 begins at 102, at which a user wishes to view a customized video concerning a topic in which they are interested. In one exemplary Internet embodiment of the present invention, a user begins the process of creating a customized video by accessing a web page on the Internet via a Uniform Resource Locator (“URL”) such as http://www.football.youdigitalmedia.com. The Web page is accessed by entering the URL into a Web browser program executed by a computing device such as computing device 400. The Web browser program may be any such commonly known program including, but not limited to, Microsoft's Internet Explorer® and Mozilla's Firefox®. The URL is the address of a resource located on the Internet that consists of a communications protocol followed by the name or address of a computer on the network. The URL may also include additional locating information such as directory, file name, and the like. In our exemplary embodiment, the entering of the URL http://www.football.youdigitalmedia.com at a computing device 400 connects computing device 400 through a network 418 (in our example, network 418 is the Internet) to a computer (i.e., in this example, server 420) having an address of http://www.football.youdigitalmedia.com. This connection allows server 420 to provide Web pages and Web page content via Internet 418 to a user of method 100 via the Web browser located on his or her computing device 400, Process 100 then proceeds to 104. Although network 418 is the Internet in the exemplary embodiment of the present invention depicted in FIGS. 1A through 4, networks other than the Internet (e.g., a Local Area Lan, Intranet, etc.) may be substituted without departing from the scope of the present invention.

Next, at 104, server 420 provides the user's Web browser with a Web page depicting various topics of interest for which customized videos may be generated. The user clicks on the topic in which he or she is interested via the appropriate input device(s) 414 of his or her computing device 400. In the example illustrated in FIGS. 1A through 4, the selected topic of interest is football, specifically National Football League (“NFL”) players. That is, when a user of method 100 selects a topic of interest, he or she is selecting a specific NFL player. The NFL player video template is designed to facilitate automatic generation of a customized NFL player video by specifying how text, image, audio and/or video content specific to an NFL player of interest may be integrated to create the customized video. It should be noted that topics of interest other than NFL players may be substituted without departing from the scope of the present invention. In addition, a user may select a topic of interest via other methods without departing from the scope of the present invention including, but not limited to, by directly accessing a Web page devoted to such topic of interest such as http://www.football.youdigitalmedia.com.

Next, process 100 proceeds to 106, at which the user is authenticated via a user name and password using a standard sub-process as is commonly known in the art. That is, at 106, server 420 displays a web page, pop-up window, or the like that prompts the user to enter his or her username and password at computing device 400. The username and password are typically alphanumeric strings associated with the particular user that are used to identify, or authenticate, the user attempting to log-in to server 420 and/or a computerized program executed by server 420. To log in, the user enters his or her username and password into the Web page, pop-up window, or the like provided by server 420, whereupon the data is submitted to server 420 for authentication when the user clicks a button such as a “login” button, “submit” button, etc.

Process 100 then proceeds to step 108, at which the user authentication data is queried by server 420 to determine if it is correct. If the data is not correct, process 100 proceeds to step 110, at which point the login screen is again displayed to the user with a notification that the user authentication data is incorrect. The user may then re-enter and re-submit his or her authentication data. Process 100 then returns to step 108 to query the authentication data again. In this manner, steps 108 and 110 are repeated until the user enters correct authentication data. When the correct authentication data is received, process 100 proceeds to 112. Alternatively, if a secure user login is not required, process 100 may proceed directly from step 104 to step 112.

At step 112, the database connection and authorization values (e.g., $host, $port, $ass, $database, etc) are set to allow server 420 to establish a connection to database 301 to allow data to be retrieved therefrom. In the exemplary embodiment of the present invention depicted in FIGS. 1A through 4, database 301 is a structured query language (“SQL”) database with a relational database management system, namely, MySQL as is commonly known and used in the art. However, other databases may be substituted without departing from the scope of the present invention including, but not limited to, PostgreSQL and Oracle databases.

Database 301 is manually programmed with information prior to execution of method 100. In our exemplary embodiment, the programmed information is that related to a plurality of NFL players including, but not limited to, names, positions, total yards thrown, touchdowns allowed per game, injuries, and the like. This information is programmed based upon the instructions provided by the provider of the MySQL database as is commonly known in the art.

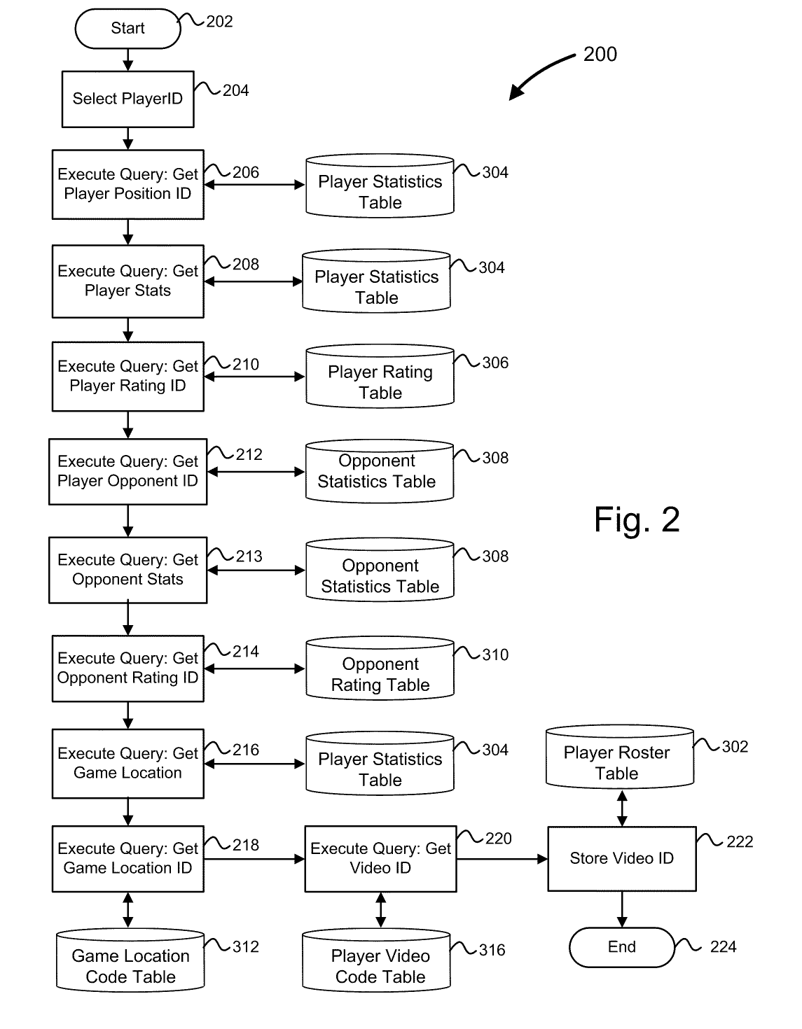

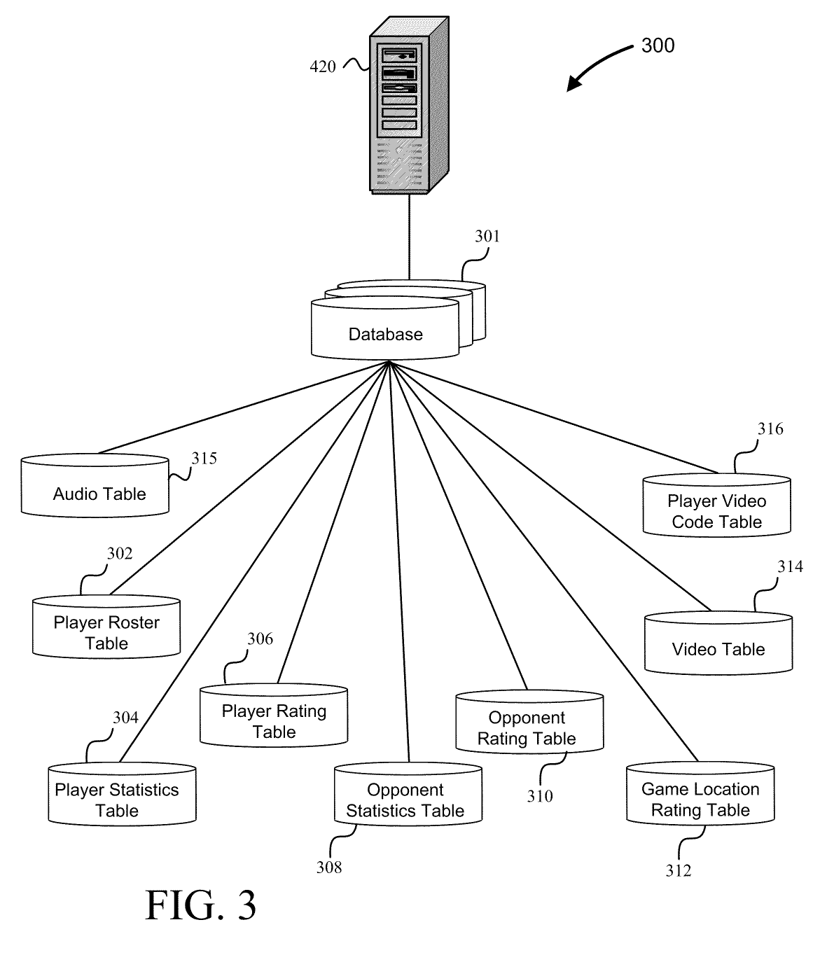

A more detailed depiction of database 301 is depicted in FIG. 3. As illustrated, database 301 exists internal to server 420. Additionally, the database information is separated into one or more tables as is commonly known in the art. In our exemplary NFL player embodiment, database 301 includes the following data tables: Player Roster Table 302, Player Statistics Table 304, Player Rating Table 306, Opponent Statistics Table 308, Opponent Rating Table 310, Game Location Rating Table 312, Video Table 314, Player Video Code Table 316, and Audio Table 315. The Player Roster Table 302 contains the names of every NFL player and their corresponding Player ID value. The Player ID value is an alphanumeric string of characters that uniquely identifies the NFL player to which it is linked. The Player Statistics Table 304 contains information regarding the performance of each NFL player during a game (i.e., number of touchdowns per game, percentage of completed passes, etc.) in addition to other relevant information for each player (i.e., player position, injury status, etc.). The Player Rating Table 306 contains information regarding nonspecific NFL player performance and corresponding player rating values as discussed in greater detail below with reference to FIG. 2. The Opponent Statistics Table 308 contains information regarding the defensive performance of each NFL player during a game (i.e., touchdowns allowed per game, yards allowed per game, etc). The Opponent Rating Table 310 contains information regarding nonspecific NFL player defensive performance and corresponding player rating values as discussed in greater detail below with reference to FIG. 2. The Game Location Rating Table 312 contains information about the locations in which the NFL players compete. Video Table 314 contains information about each stored video such as the location of each video file in the database and a unique alphanumeric Video ID value for each video. In addition, Video Table 314 contains a description of each video linked to a corresponding Video ID value. The Video ID value is an alphanumeric string of characters that identifies the content depicted in the video. Audio Table 315 contains information about each stored audio file such as the location of each audio file in the database. In addition, Audio Table 315 contains a description of each audio file linked to a corresponding Video ID value. The Video ID value is an alphanumeric string of characters that identifies the content depicted in the video. Player Video Code Table 316 contains values identifying player position, player performance, opponent performance and game location and corresponding Video ID values as discussed in greater detail below with reference to FIG. 2.

Information in database 301 may be manually updated on a periodic basis (e.g., daily, weekly, etc.) to ensure that it contains the most up-to-date information. In one embodiment of the present invention, a data entry team manually updates database 301 with information gathered from other sources (e.g., newspapers, television, the Internet, etc.). In an alternate embodiment, data is updated automatically via methods including, but not limited to, third party data feeds (e.g., Extensible Markup Language (“XML”) data feeds) and pulling data from third party databases via Application Programming Interface (“API”) scripts and the like. However, alternate methods of updating the data in database 301 may be substituted without departing from the scope of the present invention.

Referring back to FIG. 1, after the database connection and authorization values are set, process 100 proceeds to 114, at which a bi-directional database connection is established. This connection allows server 420 to communicate with database 301 to retrieve information necessary to automatically generate a customized video. That is, this bi-directional communication allows server 420 to query database 301 for a specific piece of information and to receive said information in return. Process 100 then proceeds to 116.

At 116, server 420 executes a Player ID value query for the Player Roster Table 302. That is, server 420 communicates the name of the NFL player selected in step 104 to Player Roster Table 302 via a standard SQL query in order to retrieve the corresponding Player ID value contained in that table. Each NFL player has a unique numerical value that is utilized to identify all other relevant data for the particular player. However, values other than numerical values may be substituted without departing from the scope of the present invention. The names of each NFL player are listed in one column of Player Roster Table 302 while all Player ID values are listed in a separate column. All data in a particular row are linked. That is, the name of an NFL player listed in a particular row of the table in the NFL player name column is linked to the Player ID value for that NFL player listed in the same row of a separate Player ID column. The standard query identifies the column containing the limiting information, in this instance the name of the selected NFL player, and returns a corresponding matching result. For example, if the name of the NFL player selected in step 104 is John Smith, then the query searches the NFL player name column and returns the Player ID value for the row positively matching “John Smith”. The process then proceeds to step 118.

At step 118, server 420 executes a Video ID value query to Player Roster Table 302. That is, server 420 communicates the Player ID value retrieved in step 116 to Player Roster Table 302 via a standard SQL query in order to retrieve the Video ID value contained in that table that corresponds to the Player ID value. Video ID values are matched to Player ID values via a process such as that depicted in FIG. 2. Each Video ID identifies a unique video template and/or one or more audio files to be played in the customized video. The Video ID value retrieved by the query identifies the video template and/or one or more audio files that are associated with the Player ID value at that given time since the Video IDs are regularly updated. That is, each Player ID value has a corresponding Video ID value to identify the correct video template and/or one or more audio files to be used for the player associated with the Player ID value at that given time. The Video ID value is likely to change over time based upon the current data in the database for the particular NFL player. For example, one such video ID value may correspond to a video template and/or one or more audio files for players that play the position of quarterback who having been playing very well and who are facing a difficult opponent in an upcoming game to be played at the opponent's stadium. In this scenario, the returned Video ID value will correspond to a video template and/or one or more audio files having the following characteristics: 1) the depicted player has a player position of quarterback; 2) the depicted player has a high competency rating; 3) the depicted opponent has a high competency rating; and 4) the next game to be played is an away game. The Video ID for such a player may change if, for example, the player starts playing poorly, the player faces an opponent with a low competency rating, the next game to be played is a home game, etc.

It is important to note that the video template does not have any information specific to the selected player. This information is added during the customization portion of the present invention as discussed in greater detail below. The one or more audio files may have information specific to the selected player to further customize the video including, but not limited to, the player's name, the name of the player's team, the name of the upcoming opponent. Alternatively, similar to the video templates, the one or more audio files may be generic and theme-based. In this scenario, the one or more audio files will not include any information specific to the selected player. Embodiments of the present invention are also envisioned in which a particular video may include both specific and generic audio files.

In some embodiments of the present invention, the Video ID value for each Player ID value is updated on a daily basis as discussed in greater detail below with respect to FIG. 2 to ensure that any newly-generated video is accurate and relevant. It should be noted that Video ID values other than numerical values may be substituted without departing from the scope of the present invention. The process then proceeds to step 120.

Turning next to FIG. 1B, process 100 continues via step 120. At step 120, server 420 creates a dynamic Web page using a scripting language such as PHP Hypertext Preprocessor (“PHP”) or the like. The dynamic Web page may be selected based upon the Player ID retrieved in step 116 or it may be generic to all NFL Players. In the depicted embodiment, the Web page is generic to all NFL Players. The player video to be played via the dynamic Web page is customized via the code embedded in the Web page. That is, server 420 executes the embedded code in order to automatically generate a customized video based upon the video template and/or one or more audio files associated with the Video ID retrieved in step 118. More specifically, a portion of the embedded code will cause server 420 to assign text, image, audio, and video data to all variables included in the video template and to transmit such data to the video player memory as discussed in greater detail below with respect to step 122.

Process 100 then proceeds to 122, at which the variables included in the video template associated with the Video ID retrieved in step 118 are set to equal the data associated with the current NFL Player. That is, since each video template is generic and does not include player specific information, each video template includes variable names (e.g., slidevalue001, slidevalue002, etc.) in lieu of text, image, audio, or video data. During step 122, each of the one of more audio files identified by the Video ID and each text, image, audio, and video file required by the video template (i.e., those files that are specific to the selected NFL player) are labeled with the corresponding variable name programmed in the video template. That is, when the video template is played, it incorporates the player specific text, image, audio, and video files by pulling the data from database 301 that is associated with the variable name in the video template as the variable name occurs in the video, or whose file path is associated with the variable name. In this manner, the generic video template is customized to represent the selected NFL player.

The video template variables are set to equal the desired image, text, audio, or video data, or the file path thereof, via execution of the code embedded in the Web page created in step 120. For example, if the first variable used in the video template is slidevalue012, and slidevalue012 has been predetermined to include a head shot of the NFL Player, then a portion of the embedded code directs server 420 to execute a slidevalue12 value query for the current NFL Player to the Player Statistics Table 304. That is, server 420 communicates the name of the variable (i.e., slidevalue012) and the Player ID retrieved in step 116 for the current NFL player to Player Statistics Table 304 (i.e., if the desired file is an image, text, or video file) or Audio Table 315 (i.e., if the desired file is an audio file) via a standard SQL query in order to retrieve the data or data file path associated with slidevalue012 (in this example, the location at which the image of the NFL Player's head shot is stored). The Player IDs of each NFL player are listed in one column of Player Statistics Table 304 and the corresponding data for each NFL player is listed in separate columns. Each column is associated with a particular variable such as slidevaluexxx. For example, all head shot file paths are located in the same column. Examples of data that might be included in dedicated columns include, but are not limited to, number of touchdowns per game, percentage of completed passes, total yards thrown, etc. An example of audio data includes an audio clip of commentary on the selected NFL player's most recent game. An exemplary video data might be a video clip of footage from the selected NFL player's most recent game. Whatever the data might be, each equivalent one of the data for all NFL Players is stored in the same column such that the data matching a specific NFL Player is stored on the same row as that NFL Player's Player ID.

In embodiments of the present invention in which audio files are selected based upon one or more digits of the Video ID, these audio files, or the file paths thereof, are also associated with the appropriate variable names to allow such files to be played in the customized video. In such a scenario, the video template variables are set to equal the desired audio file, or the file path thereof, via execution of the code embedded in the Web page created in step 120. For example, if the first audio file variable used in the video template is slidevalue001, and slidevalue001 has been predetermined to be the audio file associated with the last digit of the four digit Video ID, then a portion of the embedded code directs server 420 to execute a slidevalue001 value query for the current NFL Player to Audio Table 315. That is, server 420 communicates the value of the fourth digit of the Video ID and the Player ID retrieved in step 116 for the current NFL player, to Audio Table 315 via a standard SQL query in order to retrieve the data, or data file path, associated with the audio file that corresponds to the current value of the fourth digit of the Video ID. The Player IDs of each NFL player are listed in one column of Audio Table 315 and the corresponding data for each NFL player is listed in separate columns. Each column is associated with a particular correlation to the Video ID such as first digit of Video ID equals 1, first digit of Video ID equals 2, etc. For example, all audio files for a home game are located in the same column that corresponds to a fourth digit of the Video ID that is equal to one (1). In this manner, the generic video template is customized with specific and relevant audio files to represent the selected NFL player.

Although the present invention is described above as utilizing both the Player ID and one or more digits of the Video ID to retrieve the desired audio files, embodiments of the present invention are envisioned in which the Video ID is solely used to retrieve the desired audio files. In such embodiments, the audio applies to all NFL players in a similar position (e.g., poor player ranking for a quarterback facing an opponent with a high ranking in an away game).

In one embodiment of the present invention, images and/or audio are generated by the provider of the present invention. In an alternate embodiment, such images and/or audio may be bought or licensed from a third party. Also, alternate forms of generating images and/or audio may be substituted without departing from the scope of the present invention.

All data in a particular row are linked to the same Player ID located in that row. The standard query identifies the column associated with the required variable and finds the information contained in the row associated with the Player ID and returns the information as a matching result. In this example, the returned information is the file path at which the head shot for the selected NFL player is located. For example, the value of our exemplary variable slidevalue012 is set to equal this file path and this file path is transmitted to the video player memory for use when the video is played for the user. Embedded code is included in the Web page created in step 120 to instruct server 420 to associate all image, text, audio, and video data, or the file path thereof, with the appropriate variable name. Simultaneously, each image, text, audio, and video data, or the file path thereof, are sequentially transmitted to the video player memory such that they may be easily retrieved upon playback of the video for the user. Process 100 then proceeds to step 124.

In the depicted embodiment of the present invention, all audio files are stored in audio table 315. However, such audio files may be stored in alternate tables without departing from the scope of the present invention. Additionally, although the depicted embodiment executes step 122 via code embedded in the Web page created at step 120, alternate locations of this code including, without limitation, server 420 or an applet downloaded to the user's browser may be substituted without departing from the scope of the present invention.

At step 124, the last lines of the embedded code of the Web page created at step 120 (i.e., the portion of the embedded code that is executed after all other code) initiates a video player to play the video. Alternatively, the Web page generated at step 120 may include a picture of a video player and the user may play the video by clicking on the pictorial video player's “play” button. The video player may be resident on server 420 or may be located on the user's local computing device (e.g., computing device 400). Alternatively, the user may manually initiate the video player via, for example, clicking an icon on computing device 400 or via any other commonly known method. In the exemplary embodiment of the present invention, the video player is an Adobe Flash video player and it resides on server 420. Although an Adobe Flash video player is employed in the exemplary embodiment, alternate video players including, but not limited to, Silverlight, Java, QuickTime, HTML5, H.264, and Windows media players may be substituted without departing from the scope of the present invention.

When the video player is initiated, it loads the video file of the video template associated with the Video ID retrieved in step 118 of FIG. 1A as discussed in greater detail above. In one embodiment of the present invention, the video file is a Small Web Format (“SWF”) file, however, other file types may be substituted without departing from the scope of the present invention. As discussed above, in the described embodiment of the present invention, all audio, text, image, and video files have been preloaded in the memory of the video player. However, alternate embodiments of the present invention are envisioned in which these files are passed from the video player to the video file during the loading of the video file and/or while the video is playing.

Next, step 125 plays the customized video for the user. As the video file (SWF file) plays, it will display the text, image, audio and/or video data when it comes upon a variable in the file that is coded to insert and display such data (e.g., slidevalue1, slidevalue2, etc.). For example, if the video comes upon our exemplary variable slidevalue012 discussed above, the video will display the image of the head shot located at the file path associated with slidevalue012. This allows generic video templates to be customized to specific NFL players.

Not only will the SWF files be coded to display such data at specific moments within the video, but the coding will also include instructions on how to display the inputs. For example, the coding might instruct the video file to show the text for the NFL player name in the beginning of the video, in large letters, and using a colored font to match the team colors of the NFL player. The coding might also instruct the video file to display the player image on the top right hand side of the screen for 10 seconds at the end of the video clip. The variations of how the video should display the inputs are endless. Process 100 then terminates at step 126.

Turning next to FIG. 2, depicted is a method 200 for automatically assigning a video template and/or one or more audio files to a topic ID value (in this case, a Player ID value) by analyzing static and dynamic data contained in database 301 for each topic (in this scenario, NFL players). That is, a Video ID value is assigned to each Player ID value. As the dynamic data related to each NFL football player changes, (i.e., injury status, home game vs. away game, average touchdowns per game, etc.), the relevant video template and/or one or more audio files may also change. For example, if an NFL player who has been playing very well starts to play poorly, the video template and/or one or more audio files relevant to that player must be changed to reflect the NFL player's recent poor performance. To accommodate change in the dynamic data, the Video ID value assigned to each players' Player ID values is regularly analyzed and, if needed, updated to reflect such changes. That is, the Player ID value remains the same whereas the Video ID value assigned to the Player ID value changes as appropriate based upon the dynamic data associated with the player. In one embodiment of the present invention, this process is run daily in order to ensure that any automatically generated videos are current and up to date. However, this process may be run at alternate intervals (e.g., hourly, twice a day, every other day, etc.) without departing from the scope of the present invention.

Process 200 begins at step 202, at which the process for automatically assigning a video template and/or one or more audio files to a topic ID value begins. Next, at step 204, the Player ID to which a video template and/or one or more audio files will be assigned is selected. In the embodiment of the present invention depicted in FIGS. 1A through 4, each time the data in Player Statistics Table 304 is reviewed and/or updated, process 200 will be executed for each Player ID value in the database. Also, in the depicted embodiment, the Player ID values and their corresponding Video ID values are stored in Player Video Code Table 316. Process 200 may be executed for each Player ID based upon the numerical order, or other order, in which such Player IDs are stored in Player Video Code Table 316. However, other methods of executing process 200 for each Player ID may be substituted without departing from the scope of the present invention.

Process 200 then proceeds to 206, at which server 420 executes a Player Position ID query for the Player Statistics Table 304. That is, server 420 communicates the Player ID value selected in step 204 to the Player Statistics Table 304 via a standard SQL query in order to retrieve the corresponding Player Position ID contained in that table. The Player Position ID value indicates what position the NFL player typically plays. For example, if the selected player is a quarterback, then the selection of the relevant video template and/or one or more audio files is restricted to video templates and audio files pertaining to quarterbacks. Each position is assigned an alphanumeric Player Position ID value. In the example above, if a quarterback position is assigned the number one (1), then the value returned for Player Position ID is “1”. Similarly, if a running back position is assigned the number two (2), then the value returned for Player Position ID is “2”. The Player Position ID value is used to select an appropriate Video ID value as further discussed below.

Next, at step 208, server 420 executes a Get Player Stats query for Player Statistics Table 304. That is, server 420 communicates the Player ID value selected in step 204 to Player Statistics Table 304 via a standard SQL query in order to retrieve the corresponding player statistical data contained in that table. The player's statistical data includes information about how well the player has performed during all of the games played in the current season including, but not limited to, average touchdowns, average yards per game, average completions, etc. The retrieved statistical data varies based upon the player's position. The Player ID value sent to Player Statistics Table 304 allows the proper information to be returned.

Process 200 then proceeds to step 210, at which server 420 executes a Get Player Rating ID query for Player Rating Table 306. That is, server 420 communicates the player statistical data retrieved in step 208 to Player Rating Table 306 via a standard SQL query in order to retrieve the corresponding Player Rating ID contained in that table. In the depicted embodiment, this data ranges from three (3) to ten (10) different statistics. However, a lesser or greater quantity of statistics may be substituted without departing from the scope of the present invention. When Player Rating Table 306 receives the statistics, each one is weighted using a value that is manually determined and programmed in Player Rating Table 306. This value varies for each statistic and it is determined based upon the importance of the statistic relative to the other statistics applicable to the Player ID. That is, each statistic is multiplied by its own weighting value to determine the weighted statistic. Thereafter, all weighted statistics are summed to create the Player Rating ID value.

In the depicted embodiment of the present invention, the Player Rating ID value is a numerical value between one (1) and nine (9) that indicates the “rating” of a player's game performance. However, a greater quantity of rating values may be substituted without departing from the scope of the present invention. More specifically, a Player Rating ID value of nine (9) is the best rating that can be assigned and a value of one (1) is the worst player rating that can be assigned. Player Rating Table 306 is programmed such that above average player statistics will return a higher rating and below average player statistics will return a lower rating. For each statistic, Player Rating Table 306 compares the average value of all players in the NFL to the value of the statistic for the specific NFL player associated with the selected Player ID. A player whose statistical data is greater than the NFL average will receive a higher Player Rating ID value while a player whose statistical data is less than the NFL average will receive a lower Player Rating ID value. In this way, the Player Rating ID for each Player ID value will be determined based on the performance of all players in the NFL. The Player Rating ID is required to select an appropriate Video ID as further discussed below.

Next, at 212, server 420 executes a Get Player Opponent ID query for Opponent Statistics Table 308. That is, server 420 communicates the Player ID value selected in step 204 to Opponent Statistics Table 308 via a standard SQL query in order to retrieve the corresponding Player Opponent ID. The Player Opponent ID indicates the opponent against whom the NFL player associated with the selected Player ID will play during his next game. Each opponent is assigned an alphanumeric Player Opponent ID value. In the example above, if the selected NFL player is next scheduled to play against the New York Giants and this team is assigned the number one (1), then the value returned for Player Opponent ID is “1”. The Player Opponent ID value is used to retrieve the Opponent Statistical data, the latter of which is used to calculate the Opponent Rating value as further discussed below. This value is required to determine the appropriate Video ID value.

Process 200 then proceeds to 213, at which server 420 executes a Get Opponent Stats query for Opponent Statistics Table 308. That is, server 420 communicates the Player Opponent ID value returned in step 212 to Opponent Statistics Table 308 via a standard SQL query in order to retrieve the corresponding opponent statistical data contained in that table. The opponent's statistical data includes information about how well the opponent has performed defensively during all of the games played in the current season including, but not limited to, average touchdowns allowed, average yards allowed per game, etc. The retrieved statistical data varies based upon the opponent. The Player Opponent ID value sent to Opponent Statistics Table 304 allows the proper information to be returned.

Process 200 then proceeds to step 214, at which server 420 executes a Get Opponent Rating ID query for Opponent Rating Table 310. That is, server 420 communicates the opponent statistical data retrieved in step 213 to Opponent Rating Table 310 via a standard SQL query in order to retrieve the corresponding Opponent Rating ID contained in that table. In the depicted embodiment, the data may include three (3) to ten (10) different statistics. However, a lesser or greater quantity of statistics may be substituted without departing from the scope of the present invention. When Opponent Rating Table 310 receives the statistics, each one is weighted using a value that is manually determined and programmed in Opponent Rating Table 310. This value varies for each statistic and it is determined based upon the importance of the statistic relative to the other statistics applicable to the Opponent ID. That is, each statistic is multiplied by its own weighting value to determine the weighted statistic. Thereafter, all weighted statistics are summed to create the Opponent Rating ID value.

In the depicted embodiment of the present invention, the Opponent Rating ID value is a numerical value between one (1) and nine (9) that indicates the “rating” of an opponent's defensive game performance. However, a greater quantity of numerical ratings may be substituted without departing from the scope of the present invention. Specifically, an Opponent Rating ID value of nine (9) is the best rating that can be assigned and a value of one (1) is the worst rating that can be assigned. Opponent Rating Table 310 is populated such that above average defensive statistics will return a higher rating and below average defensive statistics will return a lower rating. For each statistic, Opponent Rating Table 310 compares the average value of all players in the NFL to the value of the statistic for the specific opponent. An opponent whose statistical defensive data is greater than the NFL average will receive a higher Opponent Rating ID value whereas an opponent whose statistical defensive data is less than the NFL average will receive a lower Opponent Rating ID value. In this way, the Opponent Rating ID for each opponent is determined based on the defensive performance of all players in the NFL. The Opponent Rating ID is required to select an appropriate Video ID as further discussed below.

Next, at step 216, server 420 executes a Get Game Location query for the Player Statistics Table 304. That is, server 420 communicates the Player ID value selected in step 204 to Player Statistics Table 304 via a standard SQL query in order to retrieve the corresponding Game Location contained in that table. The game location may be away, home, or bye. An away game is a game played at the opponent's stadium. A home game is a game played at the player's stadium. A game location value of bye indicates that the player's team does not play a game during the current week. Process 200 then proceeds to step 218.

At step 218, server 420 executes a Get Game Location ID query for the Game Location Code Table 312. That is, server 420 communicates the game location retrieved in step 216 to Game Location Code Table 312 via a standard SQL query in order to retrieve the corresponding Game Location ID contained in that table. In the depicted embodiment of the present invention, the Game Location ID values are one (1) for a home game, two (2) for an away game, and three (3) for a BYE week. However, a lesser or greater quantity of game location data may be substituted without departing from the scope of the present invention. The Game Location ID value is also required for selection of an appropriate Video ID. That is, appropriate video templates will be limited to those that include the correct content about the location of the upcoming game.

Process 200 then proceeds to step 220, at which server 420 executes a Get Video ID query for Player Video Code Table 316. That is, server 420 communicates the Player Position ID value, the Player Rating ID value, the Opponent Rating ID value, and the Game Location ID value determined in the previous steps 206, 210, 214, and 218, respectively, to Player Video Code Table 316 via a standard SQL query in order to retrieve the corresponding Video ID contained in that table. The selected Video ID corresponds to a current and relevant video template and/or one or more current and relevant audio files that will be used for the selected player based upon all of the above factors. Each video template and/or one or more audio files in the database are assigned an alphanumeric string of values that uniquely identifies the content of the video template and/or audio files.

In the exemplary embodiment of the present invention depicted in FIGS. 1A through 4, each video receives a four digit identification number based on the factors discussed above. The identification number is as follows: the Player Position ID is the first digit; the Player Rating ID is the second digit; the Opponent Rating ID is the third digit; and the Game Location ID is the fourth digit. For example, an identification number of 2791 would correspond to a video about a running back (2XXX) with fairly good statistics (X7XX) that is facing an opponent with excellent defensive statistics (XX9X) who is playing at home (XXX1). When server 420 executes a Get Video ID query, it returns the Video ID value corresponding to the video template and/or one or more audio files having the identification number determined by steps 206, 210, 214 and 218 above.

With respect to the one or more audio files, in the depicted embodiment of the present invention, the Video ID may correspond to one, two, three, or four different audio files. For example, our exemplary identification number of 2791 may correspond to one comprehensive audio file that includes all of the characteristics associated with the Video ID. Alternatively, our exemplary identification number of 2791 may correspond to four individual audio files, wherein each file is determined based upon one of the four digits of the Video ID and the digit's location within the Video ID. For example, the first audio file could include commentary about a running back since the value two (2) in the first location of the Video ID indicates a player position of running back. The second audio file could include commentary about a player with fairly good statistics if the second value of the Video ID is a high number such as seven (7) since this value indicates the player's rating. The third audio file could include commentary about a player that is facing an opponent with excellent defensive statistics if the third value of the Video ID is also a high number such as nine (9) since this value indicates the opponent's rating. The fourth audio file could include commentary about a player who is playing at home since a value of one (1) located in the fourth location of the Video ID indicates that the next game is a home game. In the depicted embodiment, the code embedded in the Web page created in step 120 determines how the Video ID is used to select the specific audio files. In this manner, when server 420 executes a Get Video ID query in step 118 of FIG. 1A, it returns the Video ID value that determines the video template and/or one or more specific audio files associated therewith.

Although the invention depicted in FIGS. 1A through 4 utilize the Video ID to identify a video template and/or one or more audio files, alternate embodiments of the present invention are envisioned in which the Video ID is utilized to identify only the video template or only the audio files. Or, alternatively, the Video ID may be utilized to identify any one or more of the image, text, audio, and video files. For example, if the digit of the Video ID that indicates the player's rating is poor, an image file that corresponds to that data may be selected (e.g., an image of the NFL player with a frown, in a bad mood, etc.). Conversely, if this digit of the Video ID indicates that the player's rating is very good, the selected image file may include a smiling or otherwise joyous picture of the NFL player.

Further, although the embodiment of the present invention depicted in FIGS. 1A through 4 utilizes a four (4) digit Video ID, the Video ID is not so limited. It may include lesser or greater digits without departing from the scope of the present invention.

Video templates are created to correspond to every possible player scenario that may arise. That is, in the exemplary embodiment discussed above, a video template is created to correspond to every possible combination of Player Position ID value, Player Rating ID value, Opponent Rating ID value, and Game Location ID. This ensures that an appropriate video template exists for each Video ID. Each video template is filmed and edited in a manner that allows appropriate content about any one of the many NFL players to be inserted into the video template via the use of variable names as discussed in greater detail above. Each video template, therefore, can be used for multiple NFL players. However, the video templates are also designed to include enough specificity to provide the user with the impression that the resultant video has been customized for the NFL player they have selected.

Audio files are created to either correspond to every possible player scenario that may arise or to correspond to one, or a combination of two or more, of the characteristics identified in the Video ID (e.g., a particular position, player, team etc.). That is, in the exemplary embodiment discussed above, an audio file is created to either correspond to every possible combination of Player Position ID value, Player Rating ID value, Opponent Rating ID value, and Game Location ID or to give specific details about one or more such values. Each audio file is recorded and edited to provide specific and relevant commentary on any NFL player selected by the user. The present invention may include one or both of audio files capable of being used for multiple NFL players and audio files unique to specific NFL players. In this manner, when the audio files that correspond to the Video ID are played in accordance with the video template, the resulting video provides the user with the impression that the video has been customized for their NFL player of choice.

Process 200 then proceeds to step 222, at which the Video ID value returned in step 220 is stored in Player Roster Table 302 in the same row as the corresponding Player ID value. Process 200 then ends at step 224. Process 200 is executed on a periodic basis for every Player ID.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims. For example, although a method of generating a customized video for an NFL Player is described, the systems and methods of the present invention may be used to allow customization of any generic video templates for any subject matter without departing from the scope of the present invention. Such video templates may also be further customized via the use of one or more audio files that correspond with one or more digits of the Video ID of the video template.

I claim:

1. A method for automatically creating a customized video comprising the steps of:
creating a plurality of video templates;
associating each of a plurality of available topics with one of said plurality of video templates, said associating performed based upon analysis of at least one of the group consisting of static data related to said plurality of available topics, dynamic data related to said plurality of available topics, and combinations thereof;
receiving a current topic from a viewer;
identifying a first one of said video templates associated with said current topic;
associating customizable data with each of a plurality of variables required to customize said first one of said video templates; and
presenting said customizable data associated with each one of said plurality of variables in conjunction with playing of said first one of said video templates to provide a viewer with said customized video.

2. A method according to claim 1 further comprising:
generating a Web page based upon at least one of the group consisting of said current topic, said video template, and combinations thereof, said Web page including embedded code;
wherein said embedded code performs said associating customizable data with a plurality of variables.

3. A method according to claim 2, wherein said associating customizable data with a plurality of variables includes sending said customizable data to a video player queue.

4. A method according to claim 1, wherein said customizable data is stored in at least one database.

5. A method according to claim 1, wherein said associating customizable data includes associating a file path at which said customizable data is found with one or more of said plurality of variables.

6. A method according to claim 1, wherein said customizable data includes at least one of the group consisting of text data, image date, audio data, video data, and combinations thereof.

7. A method according to claim 1, wherein said plurality of video templates are at least one of the group consisting of theme-based, story-based, and combinations thereof.

8. A method according to claim 1, wherein said associating each of a plurality of available topics with one of said plurality of video templates is performed on a periodic basis.

9. A method according to claim 1, wherein at least one of the group consisting of said plurality of video templates, at least a portion of said customizable data, and combinations thereof is identified by a Video ID.

10. A method according to claim 9, wherein said Video ID includes a plurality of digits and said at least a portion of said customizable data is identified by one or more of said plurality of digits.

11. A method according to claim 9, wherein said Video ID includes a plurality of digits and each portion of said plurality of digits identifies a characteristic of said current topic as determined by said analysis of said at least one of the group consisting of static data related to said plurality of available topics, dynamic data related to said plurality of available topics, and combinations thereof.

12. A method according to claim 9,
wherein said Video ID includes a plurality of digits and said at least a portion of said customizable data is identified by one or more of said plurality of digits; and
wherein each portion of said plurality of digits identifies a characteristic of said current topic as determined by said analysis of said at least one of the group consisting of static data related to said plurality of available topics, dynamic data related to said plurality of available topics, and combinations thereof.

13. A method according to claim 11, wherein one or more of said digits represents a weighted sum of at least one of the group consisting of static data related to said plurality of available topics, dynamic data related to said plurality of available topics, and combinations thereof.

14. A method according to claim 12, wherein one or more of said digits represents a weighted sum of at least one of the group consisting of static data related to said plurality of available topics, dynamic data related to said plurality of available topics, and combinations thereof.

15. A method according to claim 1, wherein at least one of the group consisting of static data related to said plurality of available topics, dynamic data related to said plurality of available topics, and combinations thereof are statistics related to said current topic.
